(19) United States
(12) Patent Application Publication
(10) Pub. No.: US 2005/0067482 A1
(43) Pub. Date: Mar. 31, 2005

(54) System and method for data capture and management

(76) Inventors: Daniel Huong-Yu Wu, Searingtown, NY (US); Gary Edward MacPhee, Hillsborough, NJ (US)

Correspondence Address: FITZPATRICK CELLA HARPER & SCINTO, 30 ROCKEFELLER PLAZA, NEW YORK, NY, 10112, US

(21) Appl. No.: 10/672,454

(22) Filed: Sep. 26, 2003

(51) Int. Cl. G06F 17/00

(52) U.S. Cl. 235/375

(57) ABSTRACT

A system and corresponding method for capturing, verifying, transforming and managing data from documents contained on a physical or electronic media.

### BACKGROUND OF THE INVENTION

1. Field of the Invention

This invention relates generally to the field of capturing information contained on physical or electronic media (e.g., forms, invoices, receipts, documents, e-mail, e-mail attachments, electronic files, etc.) and more particularly to extracting information contained on that media, transferring the information into an acceptable electronic format, and managing the resultant information.

2. Related Art

The vast majority of business transactions (82% according to one estimate) start with information on physical or electronic media. For example, paper forms represent one type of physical media, and are used to capture information for use in a variety of business processes. Such forms are used, e.g., in the health care industry to determine healthcare eligibility, by insurance companies to process insurance claims, by financial institutions to refinance mortgages, or by a variety of other businesses. Such information is essential in handling the day-to-day transactions of a business, and may, of course, be contained in other paper or electronic documents, such as invoices, receipts, e-mails or their attachments, electronic files, etc.

This information is typically entered into a business's computer system so that it may be cataloged, categorized, stored, accessed and/or processed. For example, businesses using paper forms typically employ data entry personnel to enter, or re-key, the information from those forms into a computer system so that it may be processed by back-office application systems. However, manual data entry processes usually suffer from a number of drawbacks. For example, such processes are characteristically costly, can be very time consuming, and are often prone to input error. These problems can quickly become exacerbated when dealing with large quantities of data, as many businesses do.

One solution for dealing with the problems of manual data entry has been to move towards automated data entry. In this way, data on documents contained on physical or electronic media is captured utilizing known computerized recognition technologies. Such recognition technologies typically capture data using optical image scanners, and include, for example, OCR (Optical Character Recognition), ICR (Intelligent Character Recognition), or OMR (Optical Mark Recognition). Generally, OCR recognizes typed data from an image and provides the ability to turn images of typed characters into machine-readable characters. ICR recognizes and interprets hand written data, providing the ability to turn images of hand printed characters into machine-readable characters. And OMR detects the absence or presence of a mark contained in a data field such as a box or small circle which is designed to be filled in by a person. In addition to automated data entry, some conventional systems provided limited data storage and archiving capabilities.

However, prior art systems are incomplete in many respects, as they do not provide the desirable features that would be helpful to businesses in managing their data. Further, the prior art systems are specific to a single business, and do not contemplate an outside service provider which extracts, transforms and otherwise manages data on behalf of its business customers, which may range from insurance to banking to healthcare. Accordingly, there is a need for a system which takes into account the rules of a customer's business or industry, as supplied by the customer, to perform compliance checking of the data. In addition, there is a need for a system which uses the content of the document or the type of the document, potentially in view of customer-supplied rules, to route the resultant extracted and/or transformed data accordingly. There is also a need for a system which may conditionally route such data, which may include text data and/or image data, to a certain destination, or to multiple destinations simultaneously.

In summary, there is a need for a system that extracts data contained on a customer's physical or electronic media, checks it for errors and corrects the same, and transforms and transports the data to the customer's premises for their applications, while providing added features such as business-rule compliance checking, conditional routing, transaction reporting and recovery, and data and/or image archiving.

There is a further need for a data capture and management service to be provided to various customers' businesses, each simultaneously servicing numerous clients.

### SUMMARY OF THE INVENTION

To overcome the problems associated with the prior art, we disclose herein systems and methods as follows.

In accordance with one aspect of the present invention, we disclose a system and method for extracting data from a document contained on physical or electronic media, and routing the extracted data to at least one of a plurality of locations depending on at least one of a content of and a type of the printed document.

In accordance with another aspect of the present invention, we disclose a system and method for automatically extracting data from a document contained on physical or electronic media, and comparing the extracted data to one or more predetermined business rules to determine whether the extracted data complies therewith. The compliant data may be routed to another location based upon the content thereof.

In accordance with another aspect of the present invention, we disclose a system and method for receiving a document contained on a physical or electronic media, scanning the document and producing an electronic file representing the data contained in the document, validating the data in the electronic file, comparing the validated data to one or more predetermined business rules to determine whether the extracted data complies therewith, and routing compliant data to one or more locations based upon the content thereof.

The document may be obtained from physical or electronic media, and may include a paper form, an invoice, a receipt, or any other type of paper document or facsimile of the same, an e-mail or e-mail attachment, a file transferred by FTP (“file transfer protocol”), or any other electronic file contained on disk, CDROM, and the like. In the case where the document is received from a facsimile, at least one dedicated inbound telephone number is provided therefor.

The scanning may utilize an OCR technique, an ICR technique, or an OMR technique.

Noncompliant documents or data may be rejected, and a notification of the same may be sent to a predetermined address. On the other hand, compliant data may be transformed into a predetermined output file format, such as ASCII text, ANSI X. 12, EDIFACT, XML, EANCOM, TRADACOMS, ODETTE, or any other customer-specific format.

The compliant data may also be archived into one or more databases. The archiving may store and index the data (for example, text or image data) in a database for later search and retrieval.

Routing may utilize a message transport protocol selected from the list consisting of HTTP, SMTP, FTP, and secure variants of these protocols.

The system and method may include the capability of generating billing records.

The system and method may also include the capability of transaction reporting and recovery, including the generation of one or more event databases regarding transaction status, and the capability to re-inject into processing any failed transaction (corrected before re-injection if feasible). The system processes a transaction through a plurality of stages, for example document receipt, data extraction, data verification, data transformation, data delivery, and data archiving. This system determines information relating to the transaction at the various stages, and reporting the same. Such information may include origin and destination, receipt and delivery date and time, status, page count, identification code, number of attempts, and the service stage. If the transaction is identified as failed, the system recovers by correcting the failed transaction, if feasible, and re-injecting it into the transaction process.

The system and method may also include the capability for querying the databases throughout the system (for example, the archive and event databases mentioned above, or any other system database).

### BRIEF DESCRIPTION OF THE DRAWINGS

The invention will be more clearly understood by reference to the following detailed description of exemplary embodiments in conjunction with the accompanying drawings, in which:

FIG. 1 illustrates a system for data capture and management according to one embodiment of the present invention;

FIG. 2 shows an exemplary list of data syntaxes, file structure and content, and segment/record data content supported by the present invention;

FIG. 3 shows an exemplary list of data re-formatting capabilities supported by the present invention;

FIG. 4 shows an exemplary list of customized conversions supported by the present invention;

FIGS. 5A-C and 6A-B provide examples which show how the present invention implements the client business rules into its operation;

FIG. 7 shows an example of a schedule used to handle the conditional routing of an inbound document through the various processing subsystems according to one embodiment of the present invention; and

FIG. 8 shows an example of the type of transaction reporting and administration provided by the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE INVENTION

The systems and methods of the present invention allow a service provider to accept documents contained on physical or electronic media from its business/industry customers, extract data from these documents, verify and correct the extracted data, compliance check the verified data against one or more predetermined business rules, transform the compliant data into an acceptable format, and deliver the transformed data to the customer. The customer may then further process the transformed data via its own applications. Many customers, such as financial institutions or insurance companies, handle information of numerous clients at once. The present invention advantageously provides, in a preferred embodiment, data capture and management service to such customers.

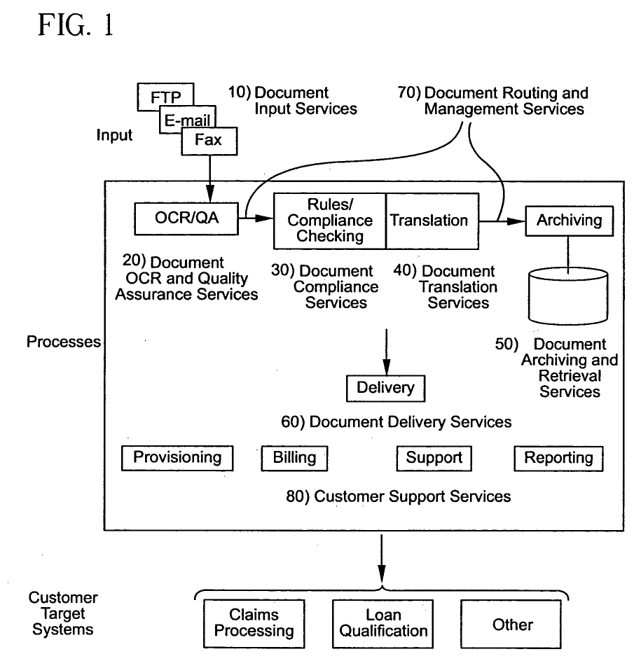

A preferred embodiment of the present invention will now be described with reference to FIG. 1.

FIG. 1 illustrates a system for data capture and management according to one embodiment of the present invention. In this embodiment, the system comprises a number of components or subsystems. Reference numeral 10 relates to Document Input Services. The present invention handles documents submitted via e-mail, facsimile, FTP (File Transfer Protocol), and other types of file or data transfer. The present invention therefore handles documents submitted in a number of different formats. For example, documents may be submitted for processing in TIFF (Tagged Image File Format) or PDF (Portable Document Format) as an e-mail attachment or as an uploaded file. As understood in the art, TIFF is a file format used for still-image bitmaps, stored in tagged fields, and application programs can use the tags to accept or ignore fields, depending on their capabilities.

In the case of e-mail submission, SMTP (Simple Mail Transfer Protocol) and secure SMTP protocol support are provided according to one embodiment. As understood in the art, SMTP is the main protocol used to send e-mail from server to server on the Internet. In the case of file submission, FTP and secure FTP services may be provided. FTP is a known method of moving files between networks and Internet sites. Other types of document or file transfer may also be handled by the present invention, and will be readily envisioned by those having ordinary skill in the art.

Documents may also be submitted as facsimile images via fax machines or via fax machine emulation software. In the case of facsimile submission, inbound dial-up access telephone numbers may be provided to each customer using the system. Customers may instruct their business partners and clients to fax relevant forms to the provided inbound numbers. When dialed, inbound service nodes provide a fax tone to the transmitting device, accept inbound fax documents in accordance with published fax protocol standards (e.g., Group 3/Group 4), and convert facsimile images to, for example, TIFF or PDF formats. Of course, the present invention is not limited to the formats discussed, and submissions may be made in other file formats as well, as will be clearly understood by a person having ordinary skill in the art.

As an alternative to providing a customer with an inbound facsimile number, the customer may port its own facsimile number to the service provider's network, so that number terminates with this system rather than with the customer. The customer may have a pre-existing toll free facsimile number for receipt of mortgage applications for processing which is published on their literature, on their website, on their business cards, in the yellow pages, on bill boards, in other advertisements, etc., and thus the customer may not desire a different facsimile number. Instead, the customer may port its own facsimile number so it terminates at the service provider's network, and thus, any documents faxed to the customer's facsimile number will be received directly by the service provider's system.

It is noted that the documents may originate from a customer directly, or may originate indirectly, for example, from a customer's agents or clients. For example, in the case of an insurance claim form (from a customer's agent) or a mortgage application (from a customer's client), the customer may not have seen the document if it was sent directly from the customer's client or agent to Document Input Services 10. The customer may see the document's information, in the form of transformed data, only after it has been delivered from the service provider's system to the customer.

In all of the above cases (e.g., an e-mail submission, a file submission, or a fax submission), the resulting TIFF or PDF image is forwarded to the Document OCR and Quality Assurance (QA) Service block 20 for further processing. Copies of data, or document images in TIFF or PDF format and the like may optionally be routed to the Document Archiving and Retrieval Services block 50 for data and/or image archiving services such as, but not limited to, long-term persistent storage. Such archiving/retrieval services will be further described below.

In the Document OCR and Quality Assurance Services block 20, TIFF and PDF image formats are scanned by one or more OCR engines. Of course, other recognition technologies could be used with the present invention as well, such as ICR or OMR. The OCR engines scan each image against a predefined form, or template, and produce a comma separated value (csv) file representing the field names and associated values corresponding to the content of the submitted TIFF or PDF image. In essence, a file of name/value pairs representing the information on the form is produced (e.g., First Name=John, Last Name=Smith, Age=32). The resulting csv file and the original TIFF or PDF image are posted to a server, where they are inspected for accuracy by human quality assurance personnel utilizing an on-line viewing application. Input data may be validated for file structure and content, and includes checks on correct hierarchical and nested record structures. The input data may also be validated for data content, including type and range checking. The manual inspection process may be used to provide information which is of insufficient quality for the OCR/ICR/OMR engines to recognize. Documents of acceptable quality are then forwarded to Compliance Services 30 and Document Translation Services block 40 for further processing as described in more detail below. Copies of such documents may optionally be routed to the Document Archiving and Retrieval Services block 50, e.g., for short-term or long-term persistent storage. Documents which fail OCR and QA processes are rejected, with a notification sent of the same to a predefined e-mail address including the rejected document as an attachment.

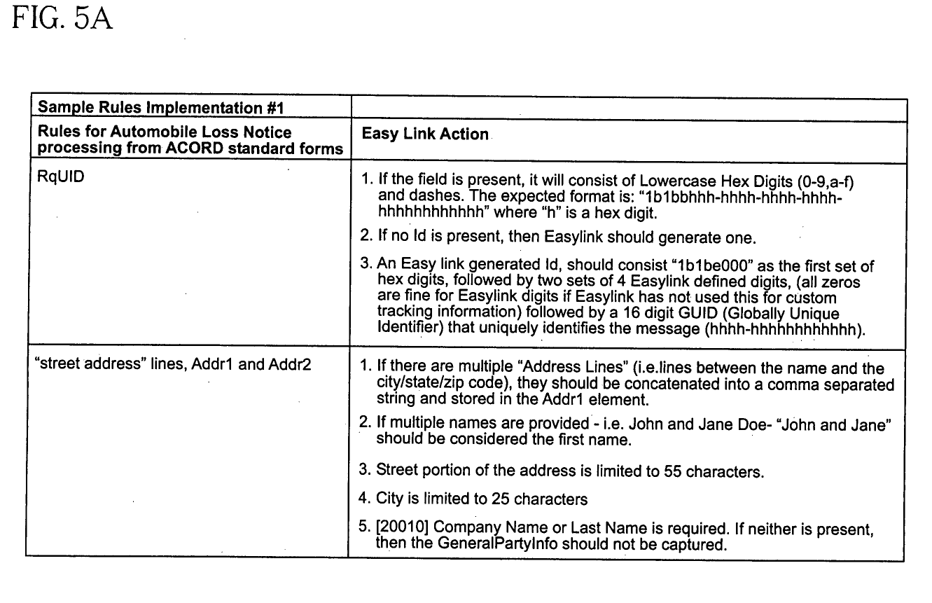

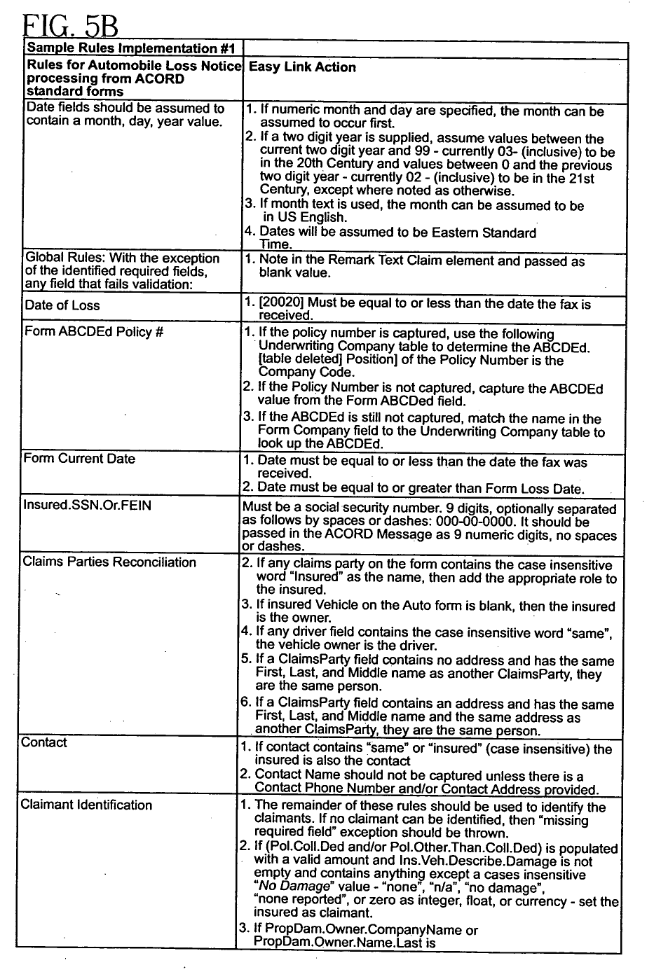

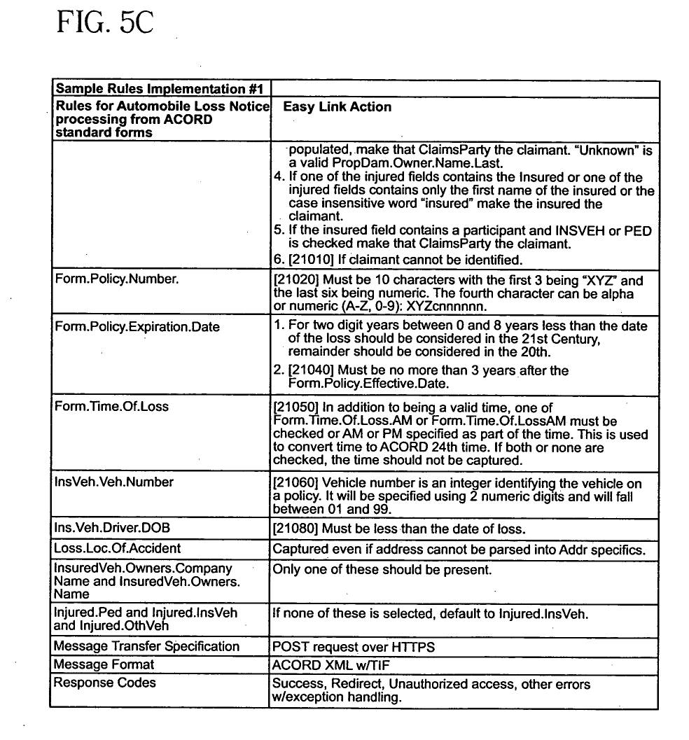

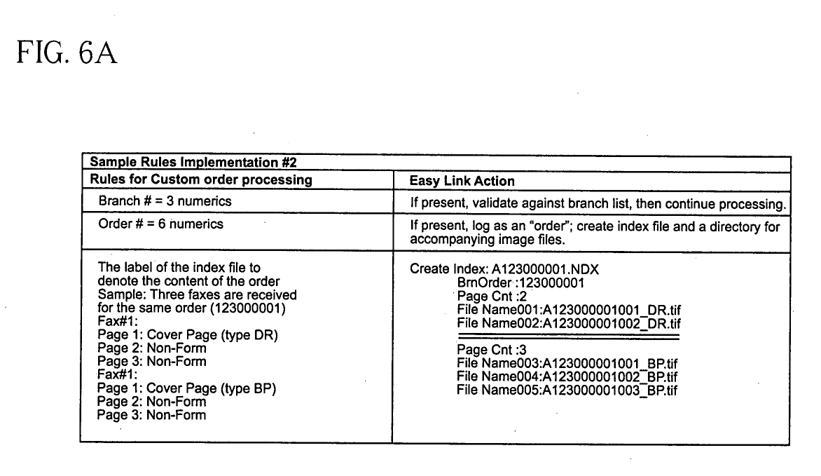

In the Document Compliance Services block 30, csv files are parsed into individual name-value pairs and analyzed against a set of business rules which may be specified during the customer implementation process. For example, csv files containing data from insurance claims may require that both the First Name and Last Name fields contain non-null values. In another example, csv files containing data from loan applications may require that the Loan Amount field be an integer less than 300,000 unless the Jumbo Loan field contains the value ‘Yes’. FIGS. 5A-C and 6A-B show examples which explain how the present invention implements the client business rules into its operation (of course, the examples in these figures are illustrative only and the present invention is not limited thereto). This feature of capturing data from received documents and validating this data against a customer's business rules is advantageous in that it takes into account the rules of the particular business or industry to perform compliance checking and to tailor the document capture and management specifically to the customer's business.

Documents which successfully pass Document Compliance Checking 30 are routed to Document Translation Services 40. Copies of such documents may optionally be routed to Document Archiving and Retrieval Services 50. Non-compliant files may be rejected with notification of the same sent to a predetermined e-mail address including the non-compliant document as an attachment.

In the Document Translation Services block 40, compliant documents are transformed into alternative file formats based upon a translation map developed during the customer implementation process. A variety of output file formats are supported, including, but not limited to, ASCII text, ANSI X. 12, EDIFACT, XML, EANCOM, TRADACOMS, ODETTE, any customer-specified formats, or flat file/csv. In this way, the present invention takes into account the particular needs of the customer. Data transformation technologies and processes are used to process the name/value pair file and to produce the corresponding output format required by the customer's back-office system. Successfully translated documents are forwarded to Document Delivery Services 60 for further processing. Copies of each successfully translated document may optionally be routed to Document Archiving and Retrieval Services 50. Files which incur errors during translation may be rejected with notification sent to a predefined e-mail address including the rejected document as an attachment.

Copies of document images in TIFF or PDF form, post-OCR csv files, and post-translation EDI, XML, flat files, and csv files, may be submitted to Document Archiving and Retrieval Services 50 for different data and/or image archiving processes. For example, one archiving process is long-term persistent storage. Indexed database records are created which merge the received document with captured indexing information to facilitate search and retrieval applications. Unique identifiers are associated with each archived document so that the documents can be easily retrieved from the archive. Customers may specify a document archive retention period. In this way, the Document Archiving and Retrieval Services block 50 enables customers to easily search for and retrieve stored information. For example, one method of search and retrieval according to a preferred embodiment is a web-based query/search facility. Of course, the present invention is not limited to this type of search/retrieval method, and other search/retrieval methods will be readily apparent to persons having ordinary skill in the art.

There are databases throughout the system which may be queried. For example, there may be billing databases which contain detailed billing records for each customer, including the costs for each stage of each transaction. The data and/or images may be archived into various databases and then later queried for search and retrieval. Transaction event logfile entries may be queried as well, for example, for status of in-progress transactions or completed transactions.

In the Document Delivery Services block 60, successfully translated documents are queued and delivered to the customer application systems utilizing a range of message transport protocols including HTTP (HyperText Transfer Protocol), SMTP, FTP, and secure variants of these protocols. Secure delivery for open protocols is provided for via SSL and Virtual Private Networking services. Legacy synchronous protocol support including 2780/3780, 3770, and LU6.2 may also be provided. In this way, successfully translated documents as data can be provided to the customer in a protocol particularly suited to the customer's needs. A globally-deployed messaging network is used to transport the converted file to customer-premises based applications.

In the Document Routing and Management Services block 70, documents are routed between and among subsystems. Routing decisions may be made on the basis of customer specific schedules developed during the customer implementation process. In this way, the content of the document and/or the type of document may be used to route the document accordingly. This provides a useful tool to businesses, for example, by enabling a business to better categorize and sort its captured business data. The document may be routed, for example, to an archive and/or to another location, such as branch offices or departmental sites, for additional services. It may be routed for immediate data and/or image archiving if the customer so chooses to set up the system in that way. Further, the extracted data, including text and image data, may be routed to a certain destination, or to multiple destinations simultaneously. For example, an extracted image may be routed to an image archive for long-term storage and the extracted text data to a customer application at their specified site for immediate processing. One or more customer sites may be specified for routing, such as the customer's main office, branch office, or departmental site. Conditional routing of a received document based on its content or type allows the customer to set up a system which is particularly tailored to the needs of its business.

Routing information may be derived from a number of different sources. For example, routing may be derived from the content of the image or form (as mentioned above), from the inbound facsimile number for faxed forms, from the IP address used for forms which are transferred via FTP, and from e-mail header information for e-mailed forms. It is noted that e-mail headers (e.g., “X” headers) can be customized and may thereby contain custom information for use in routing the data derived from the e-mail's attachments. Routing may also be derived from the type of document, as mentioned, e.g., if the type of document is a purchase order as opposed to a mortgage application. The inbound fax number and the IP addresses may be tied to a specific processing path as indicated by the customer. For example, everyone who faxes documents to “777-1234567” are presumed to be sending in automobile claims for the XYZ Insurance Co. processing center in Ohio, because this is the fax number provided for such processing.

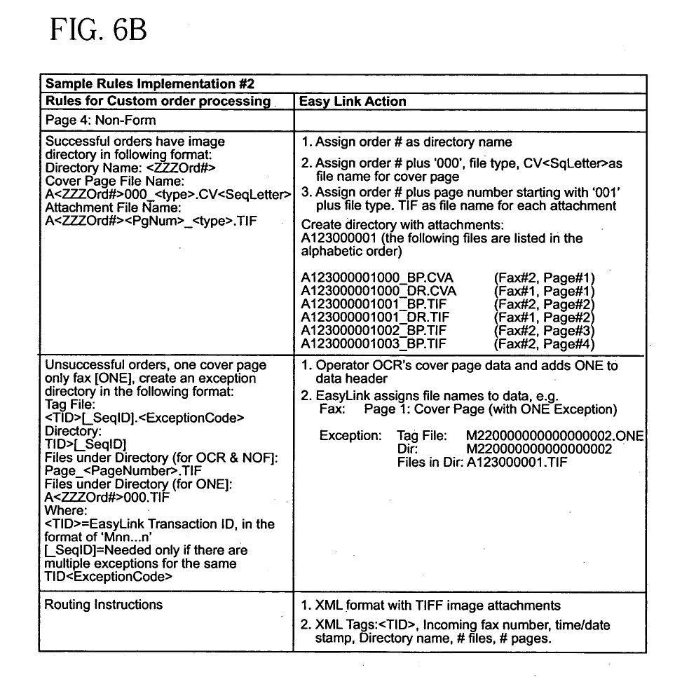

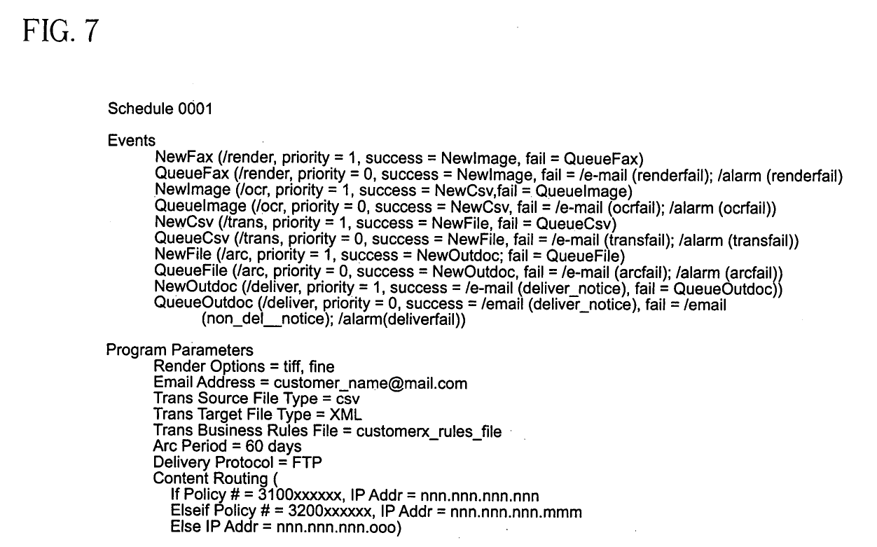

FIG. 7 shows an example of a schedule used in the Document Routing and Management Services block 70 to handle the conditional routing of an inbound document through the various processing subsystems according to one embodiment of the present invention. A schedule includes a set of events for which the Document Routing and Management Services block 70 follows and a set of parameters associated with programs which are invoked upon detecting one of the specified events. In FIG. 7, the arrival of a new inbound fax, designated as NewFax, is an example of an event detectable by the Document Routing and Management Services block 70. Per the syntax of the schedule when an inbound fax arrives, the /render application is invoked, thereby converting the inbound fax into an image file. The Program Parameters in the schedule govern the operation of the invoked programs. In this example the options for document rendering, designated as Render Options in FIG. 7, specify that the inbound fax is to be converted to a TIFF image in fine mode.

The successful completion of a process step can be configured, via the schedule, to trigger a new event. In the example of FIG. 7, the successful translation of a newly arriving csv file (see the NewCsv event statement) results in the generation of a NewFile event. The failed handling of a newly arriving csv file results in a generation of a QueueCsv event—essentially re-queuing the original transaction with a higher priority than newly arriving csv files.

It is to be noted that the schedules may also provide for the generation of delivery and non-delivery notifications. In the QueueOutdoc event in FIG. 7, successful execution of the /deliver program results in the invocation of the /email program to forward a delivery notice. Unsuccessful execution results in the invocation of the lemail program to forward a non-delivery notice. The target e-mail address for the recipient of the delivery and non-delivery notices in the example is specified on the Email Address line of the Program Parameters section of the schedule.

As mentioned, the schedule can be used to provide conditional routing based upon the content of the file. In the example of FIG. 7, the Content Routing Program Parameter identifies three different IP (Internet Protocol) Addresses to which files are routed based upon the Policy number contained in the file being processed. The schedule can also be used to provide the customer's business rules in a file, customerx_rules_file in the example. The Program Parameters of the example also include an archive retention period of 60 days, and the delivery protocol FTP. It is of course to be understood that FIG. 7 is illustrative only and the present invention is not limited to the examples shown therein.

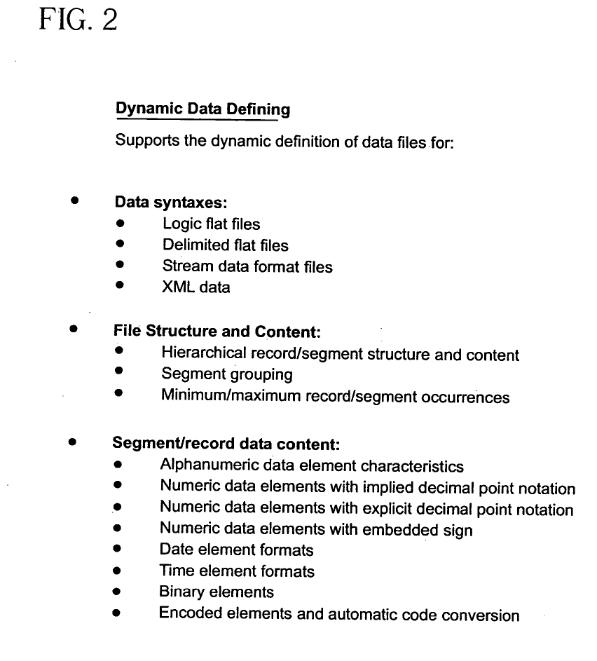

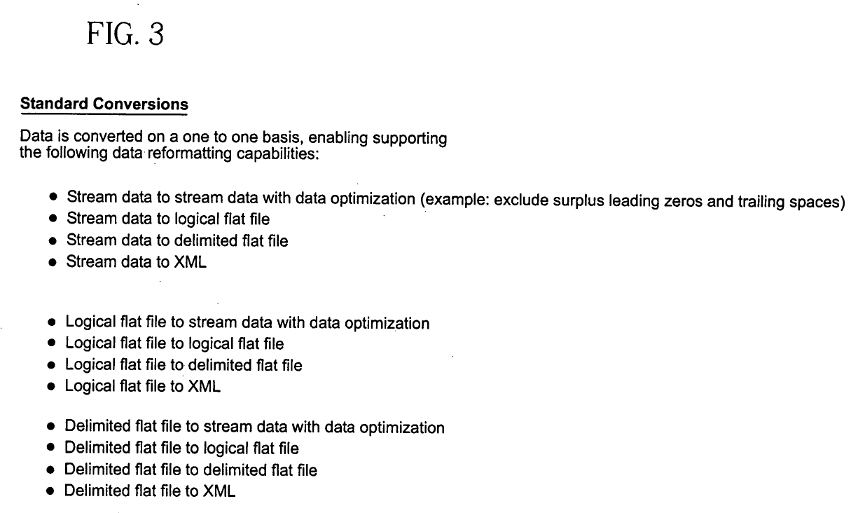

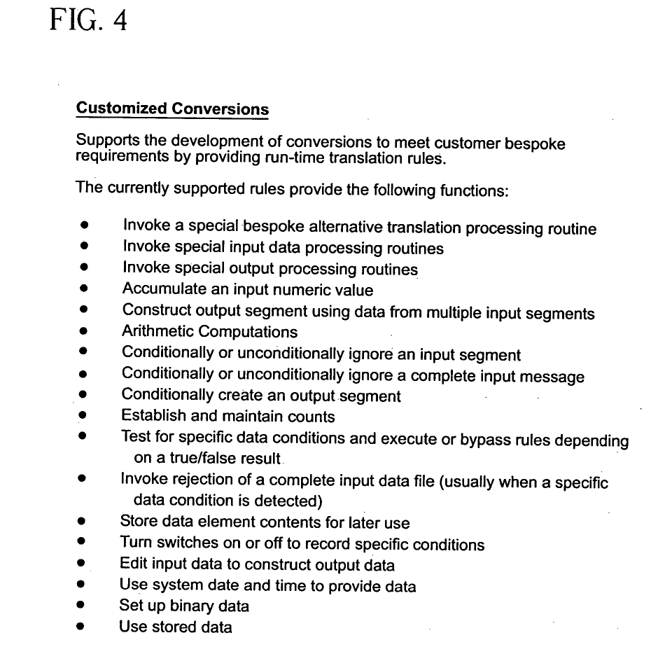

Customer Support Services 80 may include administrative tools and interfaces for provisioning optional service features and parameters, for generating billing and event records, for querying system and document status, and for reporting system and document activity on a periodic basis. Examples of provisionable features of the system include but are not limited to: specification of the input document format (e.g., TIFF, PDF) and delivery mechanism (e.g., FTP, e-mail, fax); selection of inbound dial access numbers for facsimile delivery; specification of document compliance rules; specification of document transformation rules; selection of a document archive retention period; selection of delivery protocol; and selection of a pricing plan. FIG. 2 shows an exemplary list of data syntaxes, file structure and content, and segment/record data content supported by the present invention. FIG. 3 shows an exemplary list of data reformatting capabilities supported by the present invention. FIG. 4 shows an exemplary list of customized conversions supported by the present invention. Of course, the lists shown in FIGS. 2, 3, and 4 are provided by way of example only, and the present invention is not limited to these examples.

Multiple event logfile entries are generated for each document as it passes through the various subsystems. These event logfile entries, stored in an event database, can be useful in a number of respects. For example, they can be used in status checking, in queries, or in generating billing files. Billing files may be generated against the event logfile entries to produce invoices in accordance with a pricing plan selected by the customer. Query tools are provided to assist tier support personnel in mining the content of the event database to provide customers with information regarding the status of their transactions, and to identify and resubmit failed transactions. Reporting tools are provided to enable customers to receive detailed transaction status information on a periodic (e.g., hourly, daily, weekly, monthly, etc.) basis.

The present invention affords customer interaction in a number of ways, including the following areas. First, there are administrative interfaces; that is, customers are provided with the ability to equip themselves with certain service features, e.g., to self-query system event logs for their own transactions or to self-schedule transaction reports. Access to these capabilities, in one embodiment, is provided via a web-based system administration site which requires the end user to authenticate itself via an ID/Password pair. Of course, other means of access will be readily apparent to those of skill in the art.

Second, customers initiate document processing by submitting, for example, TIFF or PDF documents to a pre-assigned e-mail address or an FTP server IP (Internet Protocol) address. Customers may also choose to initiate document processing, for example, by faxing an input document to a pre-assigned direct inbound dial telephone number.

Third, customers receive output documents from the Document Delivery Services block 60 via a supported message transport protocol as described above.

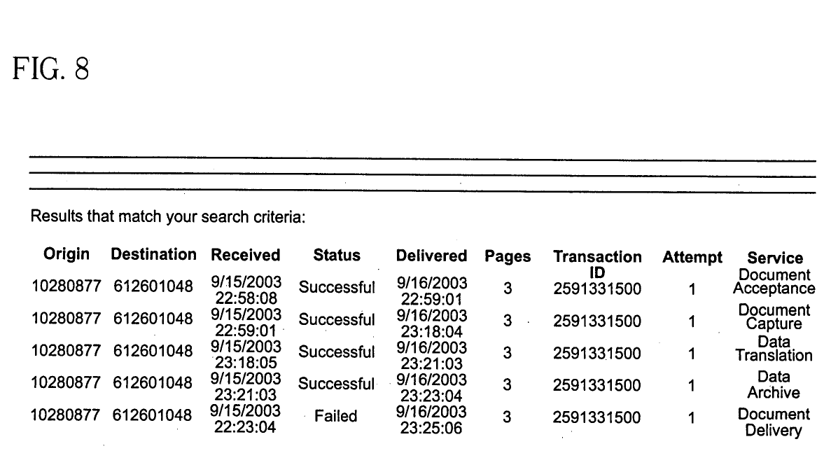

FIG. 8 shows an example of the type of transaction reporting and administration available as part of the service provided by the present invention. The administrative interface provides for the ability to view transaction summary information including information about origination, destination, send and receive times, and transaction status, whether successful or failed. It also provides for the ability to view the status of subprocess steps in the handling of business transactions. In the example provided in FIG. 8, transaction 2591331500 is traceable through each of the processing steps from acceptance to capture, translation, archiving and ultimately delivery to the recipient's host application.

The administrative interface also provides for the ability to view the document content at the completion of each subprocess step. In the example provided in FIG. 8, customers of the service, and/or Customer Service personnel, may view document content by clicking on the Transaction ID field. The document will be displayed in its form as of the completion of the process step. Documents will appear in the original TIFF image, for example, following the Document Acceptance subprocess. Documents will appear in csv or flat file format, for example, following the Document Capture subprocess.

The administrative interface also provides for the ability to retrieve transactions that have failed at a given subprocess step, correct them if feasible, and re-inject them for continued processing. In the example provided, the Document Delivery step has failed for this transaction, perhaps as a result of a communications link failure with the intended recipient of the document. Facilities are provided as part of the service to allow customer service personnel to resubmit the transaction for delivery upon diagnosing the root cause of the failure. It is of course to be understood that FIG. 8 is illustrative only, and the present invention is not limited to the examples shown therein.

Some failed transactions can be corrected for re-injection and some cannot. In particular, there are several types of errors which may arise and cause a failed transaction. For example, there may be a communication error, in which the data requires no correction. Therefore, the transaction can simply be re-injected into system processing when the communication problem is resolved. Another type of error is a data processing error. The resultant invalid data may be fixed by a review and repair process, after which the transaction may be re-injected into system processing. Still another type of error is that caused by faulty input. In this case, it may not be feasible for the system to correct the transaction for re-injection.

The ability of the present invention to provide status checking and transaction reporting is useful in other respects as well. For example, this ability provides a way for the system of the present invention to audit itself, or to check itself, to determine whether the system is in compliance with self-imposed or customer-imposed performance criteria (the latter may be specified by a service level agreement entered between the service provider and the customer). The variously compiled event logfiles may provide data to grade the performance of the system, to detect errors, or to determine how long it took to process a particular record. The destination at which a particular process has failed can also be determined. The number of attempts a certain process took to succeed can be reviewed as well. Errors can be detected easily and the data recovered. Similarly, the system can generate management reports for internal review, or external review by the customer or by others.

As detailed in this application, the present invention is advantageous to customers for several reasons. For example, it allows customers to reduce the time and expense of dealing with forms-based information received from their own clients. It provides customers with an alternative to often time consuming and costly manual data entry tasks. It further provides increased accuracy in capturing and managing this information. It enables customers to deal with non-electronic transaction sources electronically.

As detailed, the system requires little set up on the part of the customer, and is without a significant up-front expense requirement for hardware or software. The system is highly flexible and adaptable to customer needs and is cost effective as well. In addition, the system provide service to its various business customers interchangeably. For example, “image by image” regardless of its source. Once the customer's form is provisioned, the network handles each customer's document appropriately “as received.”

This system preferably runs on a series of network based servers operating in parallel. To ensure service reliability, multiple servers in a clustered configuration with automated failover techniques applied should be deployed within each architectural component of the system (block 10 through block 80 of FIG. 1). Architectural components should be joined by high speed redundant communications links, either dual 100 megabit LAN segments or redundant T1 and higher WAN links. WAN circuits connecting components of the architecture can be scaled to higher bandwidths as system volumes increase. Document Input Services 10 are most appropriately supported using Intel Pentium II servers running Red Hat Linux version 7.2 or later with 200 MHz processors, a minimum of 512 MB of RAM and 36 GB or more of local disk. Brooktrout 1034 fax boards are preferred for providing inbound fax protocol support. Document OCR and Quality Assurance Services 20 and Document Archiving and Retrieval Services 50 require a combination of Windows 2000 based servers for the OCR and Archive engines (Intel Pentium III at 800 MHz and higher with 512 MB of RAM and 36 GB or more of local disk space) and Windows 2000, XP, NT or 98 based workstations for manual QA processes (Intel Pentium III at 600 MHz or higher with 128 MB of RAM and 1 GB or more of local disk space). Document Compliance Services 30 and Document Translation Services 40 require Windows 2000 or Windows NT based servers (Dual Intel Pentium II 200 Mhz processors with 1 GB of RAM and 9 GB or more of local disk space). Document Delivery Services 60 and Document Routing and Management Services 70 require larger servers such as the 8-way Sun E4500 running Solaris 2.6 or later with 400 Mhz processors, 4 GB of RAM and A-1000 disk arrays in a 12×18 GB configuration. Customer Support Services 80 also require large servers and disk arrays to handle high volume event logging and real-time query and reporting against the stored events, preferably 8-way Sun E4500 servers running Solaris 2.9 or later with 400 Mhz processors, 8 GB of RAM and Sun Storedge 6320 disk arrays with dual disk controllers containing 4 expansion trays each with a minimum of 4 36 GB drives.

While the invention has been particularly shown and described with respect to preferred embodiments thereof, it will be understood by those skilled in the art that changes in form and details may be made therein without departing from the scope and spirit of the invention.

1. A system comprising:
means for extracting data from a document contained on a physical or electronic media; and
means for routing the extracted data to at least one of a plurality of locations depending on at least one of a content of and a type of the document.

2. A system comprising:
means for extracting data from a document contained on a physical or electronic media; and
means for comparing the extracted data to one or more predetermined business rules to determine whether the extracted data complies therewith.

3. A system comprising:
means for receiving a document contained on a physical or electronic media;
means for scanning the document and producing an electronic file representing data contained in the document;
means for validating the data in the electronic file;
means for comparing the validated data to one or more predetermined business rules to determine whether the extracted data complies therewith; and
means for routing compliant data to one or more locations based upon the content thereof.

4. The system as set forth in claim 3, further comprising means for rejecting noncompliant data and sending a notification of the same to a predetermined address.

5. The system as set forth in claim 3, further comprising means for converting the compliant data into a determined output file format.

6. The system as set forth in claim 3, further comprising means for archiving the compliant data into a database.

7. The system as set forth in claim 3, wherein the document is obtained from an e-mail, a facsimile, or a file transferred by FTP.

8. The system as set forth in claim 7, wherein in the case where the document is a facsimile, at least one dedicated inbound telephone number is provided therefor.

9. The system as set forth in claim 3, wherein the scanning means utilizes at least one of an OCR technique, an ICR technique, and an OMR technique.

10. The system as set forth in claim 5, wherein the output file format is one of ASCII text, ANSI X.12, EDIFACT, XML, EANCOM, TRADACOMS, ODETTE, and a customer-specified format.

11. The system as set forth in claim 6, wherein the archiving means stores and indexes the data in the database so that the data may be searched for and retrieved.

12. The system as set forth in claim 3, wherein the routing means utilizes a message transport protocol selected from the list consisting of HTTP, SMTP, and FTP, or secured variants thereof.

13. The system as set forth in claim 3, further comprising means for generating billing records.

14. The system as set forth in claim 6, further comprising means for querying the archive database.

15. A system for processing a transaction through a plurality of stages, said system comprising:
means for determining information relating to the transaction at one or more of said stages; and
means for reporting the transaction information.

16. The system as set forth in claim 15, wherein the information includes transaction status, further comprising means for recovering from a transaction having a status identified as failed.

17. The system as set forth in claim 16, wherein said recovery means corrects the failed transaction, if feasible, and re-injects the corrected transaction into the transaction process.

18. The system as set forth in claim 15, wherein such information includes one of at least origin, destination, receipt, status, delivery, page count, identification, attempt, and stage.

19. The system as set forth in claim 15, wherein said stages include one of at least document receipt, data extraction, data verification, data transformation, data delivery, and data archiving.

20. A method comprising the steps of:
extracting data from a document contained on a physical or electronic media; and
routing the extracted data to at least one of a plurality of locations depending on at least one of a content of and a type of the document.

21. A method comprising the steps of:
extracting data from a document contained on a physical or electronic media; and
comparing the extracted data to one or more predetermined business rules to determine whether the extracted data complies therewith.

22. A method comprising the steps of:
receiving a document contained on a physical or electronic media;
scanning the document and producing an electronic file representing data contained in the document;
validating the data in the electronic file;
comparing the validated data to one or more predetermined business rules to determine whether the extracted data complies therewith; and
routing compliant data to one or more locations based upon the content thereof.

23. A method for processing a transaction through a plurality of stages, said method comprising the steps of:
determining information relating to the transaction at one or more of said stages; and
reporting the transaction information.
